(19) United States
(12) Patent Application Publication
(10) Pub. No.: US 2004/0176076 A1
(43) Pub. Date: Sep. 9, 2004

(54) Method in a mobile network for receiving a subscriber's status and responding to an incoming call in accordance with that status

(76) Inventor: Srikanth Uppuluri, Bangalore (IN)

Correspondence Address: Docket Administrator (Room 3J-219), Lucent Technologies Inc., 101 Crawfords Corner Road, Holmdel, NJ, 07733-3030, US

(21) Appl. No.: 10/355,725

(22) Filed: Jan. 31, 2003

(51) Int. Cl. H04M 3/42

(52) U.S. Cl. 455/414.1; 455/466

(57) ABSTRACT

A mobile subscriber provides his personal status to his wireless network by selecting one of several possible predetermined statuses. A subsequent caller to the mobile subscriber's mobile station is terminated in the network with a message appropriate to the personal status selected by the called mobile subscriber if the personal status of the called mobile subscriber is anything but available.

### TECHNICAL FIELD

The present invention relates to wireless communication, and more particularly, to the handling of calls placed to a wireless subscriber.

### BACKGROUND OF THE INVENTION

In current GSM wireless systems, when a call is placed to a wireless subscriber from either a mobile or landline station, the call reaches an originating Mobile Switching Center (MSC) in the wireless subscriber's mobile Public Land Mobile Network (PLMN). If the call is from a landline station set, the originating MSC is the gateway MSC for the called wireless subscriber's PLMN. If the call is from a wireless station set, the originating MSC is an MSC that controls the area from which the call is originating. The originating MSC, be it a gateway MSC or the calling party's MSC, queries a Home Location Register (HLR) associated with the called party's PLMN to determine subscriber information and routing information to the called wireless subscriber. Specifically, the identity of the MSC, the terminating MSC that the called subscriber's mobile station is currently under the control of is stored in the HLR's database. The HLR provides that information to the originating MSC, which then establishes a connection to the terminating MSC while providing information to the terminating MSC about the particular mobile station to which the incoming call is attempting to establish a connection. The terminating MSC then contacts its associated Visitor Location Register (VLR) for its area. The VLR responds with the status of the mobile station, i.e., that it is switched off or otherwise not presently reachable, or that it is available to accept an incoming call. If the VLR determines that the status of the mobile station is not available, that information can be provided to the calling party and the call terminated by a voice response system in the network. Similarly, if the VLR determines that the mobile station is available, then the MSC signals the mobile station that it has an incoming call. The incoming call may then be accepted by the called mobile subscriber or rejected by the mobile subscriber explicitly by cancellation or by not answering the call. If the mobile subscriber rejects the incoming call explicitly, the calling party receives a disconnect or line-engage tone. If the mobile subscriber fails to answer, the call may be terminated by a voice response system. From the standpoint of the calling party, he is able to communicate with the called mobile subscriber if the subscriber accepts the call; he will know if the mobile station is turned off or is not reachable; he will not know if the call was rejected (not answered) by the recipient or there was a problem with the network; and he will be able to record and leave a message if the call is terminated by a voice response system.

### SUMMARY OF THE INVENTION

In accordance with the present invention, the concept of the personal status of a mobile subscriber is introduced that automatically provides additional information to a calling party when the called mobile subscriber has for whatever reason decided that he is unavailable to answer an incoming call. Accordingly, in accordance with the invention, the mobile subscriber provides his personal status to the network, which thereafter upon detecting an incoming call to that mobile subscriber, delivers a message appropriately associated with that status to the calling party. Thus, for example, if the mobile subscriber is currently busy and not desirous of answering an incoming call, such as being in a meeting or driving, he may wish to convey this information to a caller instead of merely switching his mobile station off. The latter action would provide no information to a caller other than the fact that the subscriber's mobile station was presently unreachable. Other examples of status information that the mobile subscriber might want to provide to a calling party without answering an incoming call may include his availability after a certain time, his availability at a specified landline number, or that he is currently taking a nap or is otherwise indisposed.

Advantageously, by providing this status information to the network, signaling resources are not wasted through the attempted set up of a call to a mobile subscriber whose mobile station status from the network standpoint is available, but whose personal status is such that he is not currently available or does not want to answer an incoming call.

In order to avoid requiring the mobile subscriber to convey his current status using a new text every time he wishes to change his status in the network, the network maintains a standard list of status messages, which each have a unique status code from which the subscriber can choose. In response to the choice by the mobile subscriber of a status message, the mobile station sends a corresponding status code to convey the subscriber's status to the network. Upon thereafter receiving an incoming call directed to that subscriber's mobile station, the network responds to a calling party with a message based on that subscriber's chosen status.

Various methods can be used for conveying the status of the mobile subscriber to the network. Specifically, in an illustrative GSM network, the status of the mobile subscriber is provided to the Home Location Register (HLR) where it is stored as an attribute in association with the subscriber's mobile telephone number together with the other afore-described information stored in association with the subscriber's telephone number. One method for the mobile subscriber to convey his status to the network uses the Unstructured Supplementary Services Data (USSD) mechanism. USSD is a standardized mechanism currently provided within GSM networks for the purpose of transporting data relating to new supplementary services that may be operator specific such as call forwarding, caller ID, and call diverting. Another mechanism uses SMS (Short Message Service) as a mechanism for conveying status information, which uses a signaling link between the mobile station and the MSC to transport information.

### BRIEF DESCRIPTION OF THE DRAWING

FIG. 1 shows the architecture of a GSM mobile network in which a mobile subscriber provides his status to the network through his mobile station, and a subsequent calling party to that subscriber's mobile station receives a message in accordance with that status when the mobile subscriber's status is other than available;

FIG. 2 is a flowchart detailing the steps for the mobile subscriber to provide his personal status to the network; and

FIG. 3 is a flowchart detailing the steps performed within the mobile network when a calling party places a call to a mobile subscriber on a network that offers this status service to its customers as an optional service.

### DETAILED DESCRIPTION

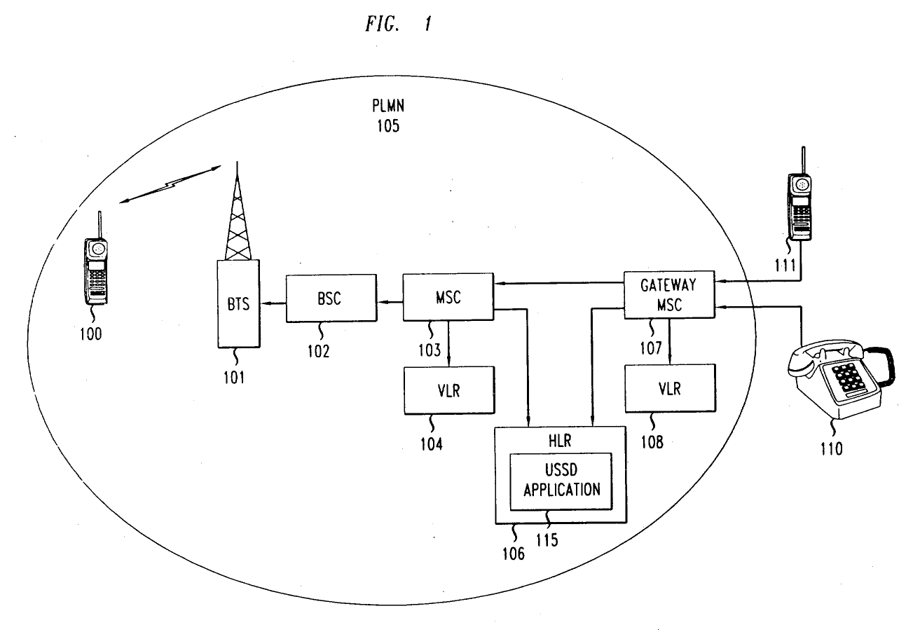

With reference to FIG. 1, a network structured according to international GSM (Global System for Mobile communication) standards is shown in which a mobile station 100 belonging to a subscriber (not shown) is within communication range of Base Transceiver Station (BTS) 101, which in turn is connected to Base Switching Center (BSC) 102. BSC 102 is connected in turn to Mobile Switching Center (MSC) 103. Associated with MSC 103 is a Visitor Location Register (VLR) 104, which maintains in its database the status of each mobile station set that is within the domain of any base station connected to MSC 103. A plurality of other MSCs and associated VLRs, such as MSC 107 and VLR 108, and others not shown, are also within the same Public Land Mobile Network (PLMN) 105 to which the mobile subscriber of mobile station 100 subscribes. Within PLMN 105, Home Location Register (HLR) 106, connected to each MSC, maintains a record indicating under which MSC each mobile station is currently controlled. Thus, in the record associated with mobile station 100, HLR 106 shows that it is currently under the control of MSC 103. All incoming calls directed to mobile station 100 from outside PLMN 105, whether from a landline phone 1 10 on the Public Switched Telephone Network (PSTN) (not shown) or from a mobile station 111 operating on a different PLMN (not shown), are connected to the one Gateway MSC (GMSC) 107 of PLMN 105 before being forwarded to MSC 103 associated with mobile station 100. GMSC 107 has its own associated VLR 108. When an incoming call arrives at GMSC 107 for mobile station 100, MSC 107 queries HLR 106 and determines that mobile station 100 is currently located in an area under the control of MSC 103. Gateway MSC 107 then establishes a connection to MSC 103, informing MSC 103 of the presence of an incoming call. MSC 103 then queries its associated VLR 104 to determine the status of mobile station 100. If mobile station 100 is available, i.e., it is not switched off and is reachable, then MSC 103 informs gateway MSC 107 and MSC 103 then handles establishing the call to mobile station 100. That call may be accepted by the called subscriber or rejected by the subscriber explicitly by cancellation or if he fails to answer it. If the mobile subscriber fails to answer, the call typically may be terminated by a voice response system in the network enabling the caller to record a message for later retrieval by the subscriber. If MSC 103 determines that mobile station 100 is switched off or is not reachable, then the incoming call is terminated in the network with a message such as “mobile is switched off” or “mobile is not reachable. If the mobile subscriber has enabled call forwarding, the call may be forwarded to another number or to a voice response system at which the caller can record a message. If a call to mobile station 100 originates within PLMN 105, then rather than transiting through GMSC 107, it will be first connected to the MSC within PLMN 105 to which the base station it is communicating with is connected. This originating MSC, assuming that it is different than MSC 103, first contacts HLR 106, as previously described, to determine which MSC within PLMN 105 mobile station 100 is currently under the control of, and then establishes a connection to MSC 103.

In accordance with the present invention, in addition to responding to an incoming call according to the status of mobile station 100, as described above, the personal status of the actual user/subscriber of mobile station 100 is used to determine whether the call is routed to the mobile station 100 or is terminated with a responsive message associated with that subscriber status. A network operator can offer this personal status service to its mobile subscribers as an added service for which the subscriber compensates it, or the network operator can universally provide the service to all of its subscribers as part of a general service package.

The ability to convey one's personal status to the network to avoid incoming calls can be advantageous to a mobile subscriber in many situations in which the subscriber does not merely want to turn off his mobile station to avoid answering a call. For example, the subscriber might be presently busy, such as in a meeting or driving, and might wish to convey this information to a caller instead of switching his device off; he might want to provide a landline number at which he can be reached; he might wish to convey a time at which he can be reached on his mobile station. Advantageously, the calling party is notified of the status of the called mobile subscriber without disturbing the subscriber, and also save the charge on a call. The mobile subscriber also saves the cost of an incoming call for which he would have otherwise accepted and merely conveyed a statement to the caller such as “call me later,” “I am in a meeting,” “I am busy,” etc. Advantageously, no attempt is made to set up a call if the mobile subscriber's is other than “available.” The network operator thus saves on the signaling bandwidth in the network and avoids the continuous ringing of a mobile station that the subscriber is not going to answer.

In conveying his status to the network, a mechanism is used in which the mobile subscriber, rather than conveying his status using a new text every time he wishes to do so, provides his status to the network from a list of possible status codes which each have an associated status message that will be played to a subsequent calling party. That subscriber status code is stored in a SUBSCRIBER_STATUS field by HLR 106 in association with the subscriber's International Mobile Subscriber Identity (IMSI). When an incoming call for mobile station 100 arrives at GMSC 107, HLR 106 is queried and if that station's SUBSCRIBER_STATUS is anything other than “available,” then the call, rather than being forwarded to MSC 103, is terminated and the appropriate recorded message is delivered. Optionally, a voice response system (not shown) allows the calling party to leave a message if the SUBSCRIBER_STATUS is other than “available.” The individual message associated with each or some of the possible status states from which the subscriber selects can be a network generated message or a message that has been pre-recorded by the subscriber and stored in the network.

Various mechanisms can be used to convey the status of the mobile user to the network. As an illustrative example, the Unstructured Supplementary Services Data (USSD) is a mechanism that is provided within GSM standards for the purposes of introducing new supplementary services that may be operator specific. Such services include call forwarding, caller ID, and call diverting. Mobile stations that are compliant with GSM standards are capable of sending a USSD string to the network where a string is a sequence of digits and (#, *). For example, a typical sequence could be **<Service-Code>#<Service-Information>#SEND. The service code field is used to specify for which supplementary service a certain operation is being performed. The service information field is used to provide additional data specific to that service. All USSD strings sent by a mobile station reach that mobile's MSC and associated VLR. A USSD application in the MSCNLR checks the service code field. If it is in the range of 150-199, the application processes this string further. If the service code is in the range of 100-149, the MSC/VLR transparently forwards the string to the HLR where the USSD application in the HLR processes the command. Both the mobile station and the network are capable of initiating USSD operation and may communicate through a USSD session using USSD REQUEST and FACILITY messages. USSD is described in the GSM standard 04.90.

For the present embodiment, USSD is used for enabling the mobile subscriber of mobile station 100 to: convey his current status to the network using a status code; download a list of possible status messages from which to choose as a current status and then convey that selection; and determine his current status. The USSD application 115 running on HLR 106 processes the USSD messages from mobile station 100 and all other mobile stations within PLMN 105. The network operator will thus select for this status service a Service-Code in the range of 100-149. The Service-information codes are network operator-specified values that indicate to the network that the mobile user wishes to perform a certain operation specific to this service. For example, the operator can select an unused service code, which for purely exemplary purposes herein is chosen to be “120”. Further, for purely exemplary purposes, the Service-information to download a list of status messages may be designated by the operator to be “255”; the Service-Information to check the current status of the mobile subscriber may be “254”; and the Service-information may be a status code itself that directly represents a specific status message. Thus, if the mobile user wants to download a list of status messages, he enters **120#255#SEND; if he wants to check his current status, he enters **120#254#SEND; and if he knows, for example, that “03” is the specific code for the status message “I'm in a meeting” that he wants to select, he enters **#120#03#SEND. For all examples, the sequences of digits sent by the mobile user are nothing but USSD commands that are formatted according to the standard GMS 02.30—Man Machine Interface of the Mobile Station.

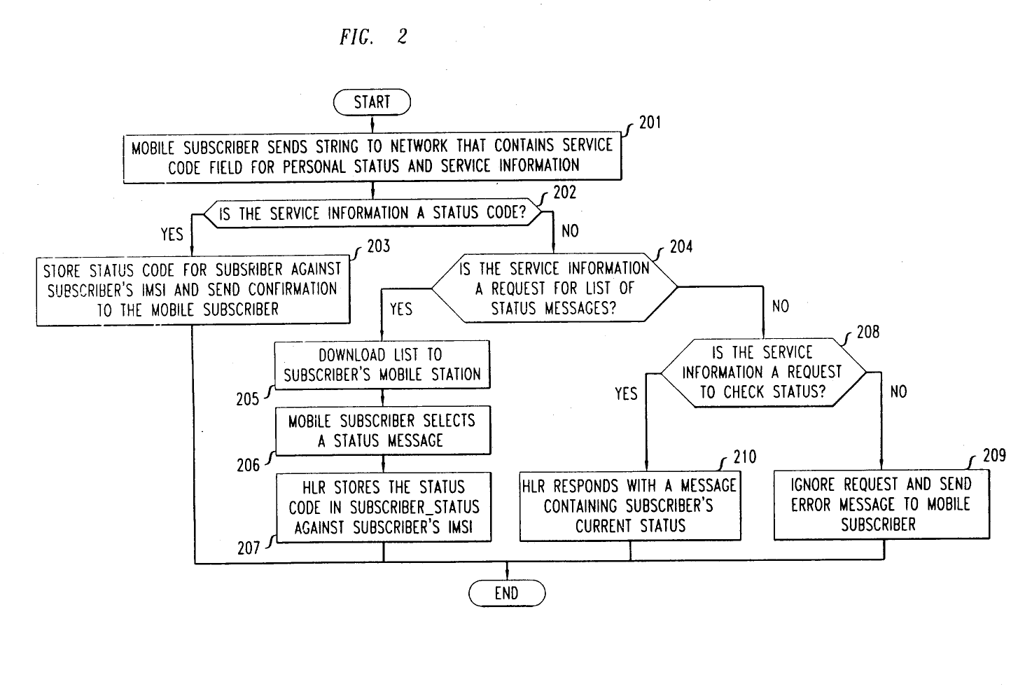

With reference to the flowchart in FIG. 2, the procedures for establishing the status of a mobile subscriber within the network is shown. At step 201, and as described in the example above, the mobile subscriber sends a USSD string to the network containing the service code field, the service code for this status service, and associated service information. At step 202, the HLR determines whether the service information is one of the valid status codes. If it is a valid status code, then at step 203, that status code is stored in the SUBSCRIBER_STATUS field against the subscriber's IMSI, and a confirmation is sent to the mobile subscriber. If the service information is not a valid status code, a determination is made, at step 204, whether the service information is recognized as being a request for a list of status messages. If it is, then, at step 205, the HLR responds by downloading a list of status messages via one or more USSD messages. At step 206, the mobile subscriber selects one of the status messages and, at step 207, the HLR stores the selected status code in the SUBSCRIBER_STATUS field against the subscriber's IMSI, and sends a confirmation to the mobile subscriber. If the chosen status is one that requires the mobile subscriber to input additional information, such as, for example, a status that provides a landline telephone number where the mobile subscriber can be reached, or a time at which the mobile subscriber will be available to be reached on his mobile terminal, then a USSD request is initiated by the network that elicits a response from the mobile subscriber to provide the necessary further information. If, at step 204, the service information is not a request for a list of status messages, then, at step 208, a determination is made whether the service information is a request to check the mobile subscriber's current status in the network. If it is not, then at step 209, the USSD message was sent in error, and the network ignores the request and a USSD message is sent back to the subscriber indicating that an improper request has been received. If it is a request to check current status, then, at step 210, the HLR responds with a USSD message containing the subscriber's current status in the network as it is currently stored in the SUBSCRIBER_STATUS field against the subscriber's IMSI.

In presenting a list of status messages to the mobile subscriber, the network operator can employ a user-friendly mechanism via the SIM Application Toolkit. Via this mechanism, a menu-based service can be provided to the subscriber. The network operator may also use any other mechanism in order to present a list of status messages to the mobile subscribers, such as, for example, the USSD Menu Browser from SICAP.

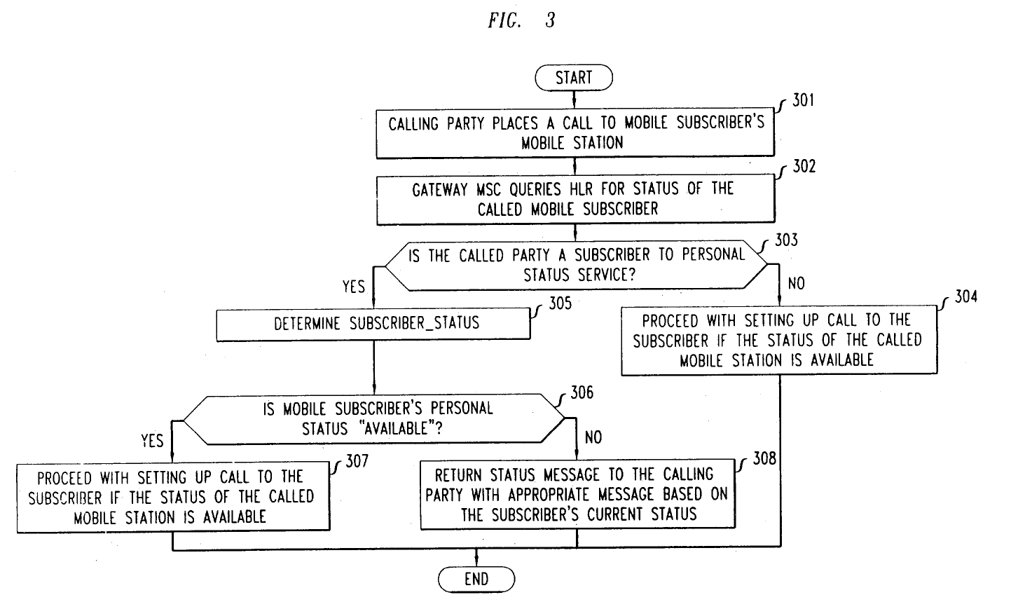

The flowchart in FIG. 3 shows the response of the mobile network to an incoming call to a mobile subscriber. At step 301, the calling party from either within the called party's mobile network, from another mobile network, or from a landline phone, places a call to the mobile subscriber. At step 302, the gateway MSC of the mobile subscriber's mobile network queries the HLR to determine the status of the called party. If the status service is not universally deployed as a feature to all of the network's customers, at step 303, a determination is made whether the called party is a subscriber to the status service. If the called party is not a subscriber, then, at step 304, call setup proceeds to the mobile subscriber in a normal manner as if the personal status of the subscriber is available. Thus, if the mobile subscriber is not available for whatever reason, the call will likely terminate with a message that that the subscriber cannot be reached. If, at step 303, the called-mobile subscriber is a subscriber to the status service, then, at step 305, the value of SUBSCRIBER_STATUS associated with the subscriber's IMSI at the HLR is determined. At step 306, a determination is made whether the mobile subscriber's status is available. If it is, then, at step 307, call setup to the subscriber's mobile station proceeds in a normal manner. If the mobile subscriber's status in not available, then, at step 308, the call is terminated using a voice response system that responds with a message that is appropriate to the SUBSCRIBER_STATUS value that the mobile subscriber had previously chosen.

Although described above as using USSD as the mechanism for conveying status information between the mobile subscriber and the network, other mechanisms could also be employed. For example, the Short Message Service (SMS) can be used as the signaling link between the mobile station and the MSC to transport status information. This mechanism could be used for those types of networks that do no support USSD. For example, whereas USSD is implemented in GSM networks, it is not supported in CDMA networks where, however, SMS is implemented. With SMS, a special number would be specified by the network operator for the status service, such as, for example, “999”. The mobile subscriber through his mobile station would then make all requests by sending them to that designated number for the status service.

Although the present invention is described as being used in a GSM network, the present invention can be employed in any type of network using any type of wireless technology, such as CDMA or TDMA. Further, the mobile station can be any type of audio or multimedia mobile station capable of receiving incoming audio and/or video calls of any type, such as, for example, a phone-equipped PDA, or any other type of phone-equipped device. Further, although described in connection with a mobile station set in a wireless network, where generally it would be most advantageous to the called subscriber to avoid the cost of an incoming call when otherwise occupied, the present invention could also be employed in a landline network where a subscriber might be desirous of providing his current status to the network when he is temporarily unavailable. Thus, the subscriber would avoid having to change a message in his local or network-centric answering machine, would avoid being interrupted by a ringing telephone, and the called party would be terminated in the network with a message appropriately associated with the personal status selected by the called subscriber.

The foregoing merely illustrates the principles of the invention. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be further appreciated by those skilled in the art that the block diagrams herein represent conceptual views embodying the principles of the invention. Similarly, it will be appreciated that the flowchart represents various processes that may be substantially represented in computer readable medium and so executed by a computer or processor, whether or not such computer or processor is explicitly shown.

The invention claimed is:

1. A method in a network for handling a call received from a caller that is directed to a called party's terminal, the method comprising the steps of:
determining the personal status of the called party, the personal status of the called party being stored in the network in association with an identification of the called party's terminal in response to a earlier input received from the called party's terminal that provides to the network the called party's personal status, the personal status indicating whether the called party is available or not available to take an incoming call; and
if the personal status indicates that the called party is not available to take an incoming call, sending a message to the caller that is associated with the called party's personal status and indicates to the caller that the called party is not available.

2. The method of claim 1 wherein the personal status earlier received from the called party's terminal is selected by the called party from among a predetermined plurality of different personal statuses, which selected personal status is stored in the network in association with an identification of the called party's terminal, and if the called party's personal status is determined to be one of a predetermined number of different unavailable statuses, then the message sent to the caller is associated with and indicates the particular selected unavailable status

3. The method of claim 2 wherein the network is a mobile network and the terminal is a mobile terminal.

4. The method of claim 3 wherein a message associated with an unavailable status provides a landline telephone number at which the called party can be presently reached.

5. The method of claim 3 wherein a message associated with an unavailable status provides information as to when the called party can be reached.

6. The method of claim 3 wherein a message associated with an unavailable status provides information as to why the called party is not available.

7. The method of claim 3 wherein the input received from the called party's terminal provides the called party's personal status via one or more USSD messages.

8. The method of claim 3 wherein the Short Message Service is used as the signaling link for receiving the input from the called party's terminal that provided the called party's personal status.

9. A method in a network over which a user of a terminal communicates, the method comprising the step of:
storing in association with an identity of the terminal, a personal status of the user in response status information received from the user's terminal, the status information indicating whether the user is available or not available to take an incoming call directed to the terminal.

10. The method of claim 9 wherein the status information received from the user indicates a selection by the user of one of a predetermined plurality of different personal statuses.

11. The method of claim 10 wherein the network is a mobile network and the terminal is a mobile terminal.

12. The method of claim 10 wherein the status information received from the user's terminal is received as a one or more USSD messages from the mobile terminal.

13. The method of claim 10 wherein the status information received from the user's terminal is received by a Short Message Service signaling link.

14. The method of claim 11 wherein the user's mobile terminal is sent a list of the predetermined plurality of different statuses for the user to chose amongst.

15. The method of claim 9 further comprising the step of:
sending the stored personal status of the user to the user's terminal in response to a received request for that personal status.
